(19) United States
(12) Patent Application Publication
(10) Pub. No.: US 2010/0049395 A1
(43) Pub. Date: Feb. 25, 2010

(54) METHODS AND APPARATUS FOR MONITORING VEHICLE DATA

(75) Inventors: Ashley Duddle, Dorset (GB); Ron Stilliard, Dorset (GB); Steve Perham, Dorset (GB)

Correspondence Address: MICHAEL BEST & FRIEDRICH LLP, 100 E WISCONSIN AVENUE, Suite 3300, MILWAUKEE, WI, 53202, US

(73) Assignee: AIRMAX GROUP PLC, Verwood, Dorset (GB)

(21) Appl. No.: 12/091,013

(22) PCT Filed: Oct. 20, 2006
(86) PCT No.: PCT/GB2006/003897

§ 371 Date: Feb. 9, 2009

(30) Foreign Application Priority Data
Oct. 20, 2005 (GB) 0521323.6

(51) Int. Cl. G06F 7/00; B23P 6/00; H01Q 17/00; B23P 19/00

(52) U.S. Cl. 701/33; 701/29; 29/402.08; 29/601; 29/747

(57) ABSTRACT

The invention relates to a method of installing a vehicle data-monitoring device and a substitute vehicle data connector into a vehicle having a vehicle data-monitoring system with an existing vehicle data connector, the method comprising the steps of: removing the existing vehicle data connector from a socket in the vehicle; inserting the substitute vehicle data connector into the socket; connecting the vehicle data connectors such that the existing vehicle data connector is in communication with the vehicle data-monitoring device and also in communication with the substitute vehicle data connector.

This invention relates to methods and apparatus for monitoring vehicle data. More particularly, but not exclusively, the invention relates to a method of installing a vehicle data-monitoring device to a vehicle diagnostic system for extracting data therefrom.

All new vehicles sold in the European Community are fitted with on-board devices for monitoring the status and performance of the engine. These were introduced in order to monitor emissions related to vehicles with a view to reducing harmful emissions. These monitors are accessed through a standard interface known as the European On Board Diagnostics Interface (EOBD). Despite being an apparently standard interface, the only mandated pre-designated output port is that of the vehicle emissions related data. Other data is often available from the same connector and using the same protocols, but may not be made generally available. Even the physical external conformation of the male and female adapters of EOBD connectors can vary between manufacturers. There is also an American equivalent on-board diagnostics standard, identified by the abbreviation OBD.

Each vehicle manufacturer tailors a number of output ports of the socket to carry data relating to a number of other parameters of vehicle performance. Such data can be derived from sensors throughout the vehicle, for example; speed, distance, tachometer data, fuel consumption data, and electrical fault data. Sensor values outside of an acceptable range trigger a Diagnostic Trouble Code (DTC). These DTCs are generated and can be used to illuminate warning lamps or displays on the vehicle's dashboard and are also stored for download by technicians when the vehicle is serviced.

One problem associated with current on-board diagnostic systems is the need, during maintenance, to take the vehicle off the road in order to carry out a diagnostic check. This can result in vehicles failing between maintenance periods. Also, this has significant cost implications for businesses running large fleets of vehicles where a relatively large proportion of vehicles may be off the road for maintenance at any one time and alternative arrangements must be made for drivers whose vehicles have broken down. It is also possible for a vehicle to generate faults that do not illuminate warning lamps.

Further disadvantages can be associated with the requirement to take the vehicle to a garage to perform the diagnostic check. A mechanic in the garage who performs the diagnostic check will analyse the diagnostic data obtained from the EOBD to determine whether or not certain maintenance work needs to be performed on the vehicle. The owner of the vehicle must rely on the mechanic to correctly, and honestly, analyse the data in order that potential faults are not missed, and that unnecessary work is not performed to fix something that is not faulty. Even if there is no inflation of the work necessary, there can be a fear in the mind of the customer that there might be.

According to a first aspect of the present invention there is provided a method of installing a vehicle data-monitoring device and a substitute vehicle data connector into a vehicle having a vehicle data-monitoring system with an existing vehicle data connector, the method comprising the steps of:
removing the existing vehicle data connector from a socket in the vehicle;
inserting the substitute vehicle data connector into the socket;
connecting the vehicle data connectors such that the existing vehicle data connector is in communication with the vehicle data-monitoring device and also in communication with the substitute vehicle data connector.

The vehicle data-monitoring device may provide information to users who are not “approved” mechanics interrogating the existing vehicle data connector. The vehicle may have an OBD or EOBD processor which can provide data via the substitute vehicle data connector.

Installing a vehicle data-monitoring device in this way enables a mechanic/technician to connect their data reader to the substitute vehicle data connector in the same way that they would connect their data connector to the existing vehicle data connector, whilst enabling data to be monitored independently by the data-monitoring device. They may not even notice that the substitute vehicle data connector is not the existing, original, vehicle data connector.

The method may further comprise connecting the existing vehicle connector to the substitute vehicle data connector with a first cable having a vehicle connector end and a substitute vehicle data connector end. The method may further comprise connecting the existing vehicle connector to the vehicle data-monitoring device with a second cable having a vehicle connector end and a vehicle data-monitoring device end.

The vehicle connector end of the first cable may be the same connector as the vehicle connector end of the second cable. The second cable may split off from the first cable.

The substitute vehicle data connector may be the same type as the existing vehicle data connector, and may have OEBD interfaces. This can help ensure that the mechanic can connect to the vehicle data-monitoring system in the same way as if the data-monitoring device were not installed into the vehicle (only the original, existing, vehicle data connector installed). It can also help to reduce the chances of the mechanic becoming aware that the vehicle data-monitoring device has been installed into the vehicle, thereby avoiding possible concern or confusion on the part of the mechanic.

The method may further comprise connecting an antenna to the data-monitoring device, which may be arranged to transmit over a mobile telephony network. The antenna enables data that is monitored by the data-monitoring device to be transmitted to a remote network.

The data-monitoring device may be installed such that it is obscured from view (e.g. when the vehicle bonnet/hood is lifted up), and preferably is installed in a cavity behind the socket or in a suitable location behind the vehicle's trim or hidden underneath the dashboard. The first cable and/or second cable may also be connected such that they are obscured from view, preferably in a cavity behind the socket. Obscuring the components from view can reduce the chances that a mechanic will become aware that the components have been fitted to the vehicle. Obscuring the component will also reduce the chance of the driver or a passenger, or an unauthorised user of the vehicle either deliberately or accidentally damaging or disconnecting the device or tampering with it's operation.

The antenna may also be connected such that it is obscured from view.

The vehicle data-monitoring system may be a vehicle diagnostics system.

According to a second aspect of the invention there is provided a kit comprising a data-monitoring device, data transfer means having a substitute vehicle data connector, and a set of instructions for installing the data-monitoring device and data transfer means into a vehicle having a vehicle data-monitoring system with an existing vehicle data connector, wherein the data transfer means is arranged, in use, to provide a communication path between the data-monitoring device and the existing vehicle data connector, and also to provide a communication path between the substitute vehicle data connector and the existing vehicle data connector.

The substitute vehicle data connector may be the same type as the existing vehicle data connector associated with the vehicle data-monitoring system, and may be OEBD interfaces.

The data transfer means is preferably a cable. The cable may be releasably attachable to the data-monitoring device, or it may be integral with the data-monitoring device.

The kit may further comprise an antenna arranged to transmit data from the data-monitoring device, preferably over a mobile telephony network.

The communication path between the existing vehicle data connector and the data-monitoring device may be interrupted when data is transferred between the existing vehicle data connector and the substitute vehicle data connector. The communication path between the existing vehicle data connector and the data-monitoring device may be resumed when data transfer between the existing vehicle data connector and the substitute vehicle data connector ceases. This can help reduce the chances that a mechanic becomes aware of the data-monitoring device when they connect a data reader to the vehicle data connector. The mechanic's data reader may be able to signal to the mechanic when a third-party device is simultaneously receiving data from the vehicle data-monitoring system.

According to a third aspect of the present invention there is provided a vehicle comprising a vehicle data-monitoring system with an existing vehicle data connector, a data-monitoring device and a substitute data connector, wherein the existing vehicle data connector is in communication with the data-monitoring device and also in communication with the vehicle data connector.

According to a further aspect of the present invention there is provided a vehicle data monitoring device, suitable for operating in a motor vehicle when the motor vehicle is in use, comprising an input port, an output port, a processor and a transceiver unit, the input port being arranged to receive vehicle telemetry and/or diagnostic data from a data bus of the vehicle, the processor being arranged to process the telemetry and/or diagnostic data and to selectively route the processed telemetry and/or diagnostic data via either, or both, of the output port or/and the transceiver unit.

The transceiver unit may be arranged to receive and/or transmit data to or from the device, for example, the processed telemetry and/or diagnostic data.

Such a unit allows in-line sampling of telemetry and/or diagnostic data whilst the vehicle is in use. This in-line sampling of data allows continuous monitoring of vehicle performance and fault sensors whilst the vehicle is in use.

The transceiver unit can be used to transmit data to a base station where the vehicle's performance can be monitored. For example an upward trend in engine temperature may indicate the onset of a problem with the vehicle's coolant system. Early notification of this will allow a fleet manager to bring the vehicle in for servicing prior to the vehicle failing and will improve fleet management.

The input port may be connectable to an output port of a data bus of an on-board diagnostics system of the vehicle, for example an EOBD or an OBD port.

The transceiver unit may be arranged to output data to a base station either periodically or continually. Typically, the transceiver unit may be arranged to transmit selected data, for example total distance travelled, to a base station periodically, for example weekly or fortnightly, whereas when the processor senses a fault the fault condition data may be transmitted to the base station continuously (or substantially so, for example every second, or every 10 seconds, or more or less frequently).

Such selective data transmission reduces the airtime and bandwidth used in transmitting data to the base station by prioritising the data to be transmitted.

The device may be arranged to monitor a data bus (vehicles typically have a data bus) to detect if a data reader is connected to the data bus and to selectively disconnect from the bus should a data reader be connected to the data bus. This may be performed by sampling the bus to detect when data is being pushed onto the bus by the reader. Alternatively, or additionally, the device may be arranged to receive data corresponding to current and/or voltage drawn by a data reader connected to the data bus and to selectively disconnect from the bus should a data reader be connected to the data bus.

This results in the device disconnecting from a diagnostic data bus when maintenance is carried out on the vehicle, allowing a technician to access the telemetry and diagnostic data without the influence of the device being connected to the diagnostic data bus.

All vehicles are required to support one or more of a defined set of standard electrical and higher level protocols and the processor may be arranged to sense to which type of vehicle data bus the device is connected and to configure the device input and output ports appropriately by searching through the possible protocols. Typically, this need only be performed once since the vehicle will not normally change protocols once manufactured.

A single device can contain the configurations on-board diagnostics systems of a number of vehicle manufacturers and or vehicle models. This allows standard components to be used thereby simplifying manufacture of the device over bespoke arrangements.

The device may comprise a data storage device arranged to receive data from the processor. The data storage device may be arranged to store data corresponding to a log of telemetry and/or diagnostic data, the data having been generated at the processor. The data corresponding to the log may be accessible by a data reader via the output port and/or via the transceiver unit. Alternatively, the data accessible by the data reader may bypass the device.

The processor of the vehicle data monitoring device may be arranged to generate a fault code data, for example Data Trouble Codes (DTCs), corresponding to telemetry and/or diagnostic data having a value outside of a pre-determined threshold criterion.

The processor may be arranged to store the fault code data on the storage device. Alternatively, or additionally, the processor may be arranged to selectively route the fault code data to either, or both, of the output port or the transceiver unit. The processor may be arranged to capture telemetry and/or diagnostic data following a pre-imposed trigger event has occurred in the data. The processor may be arranged to capture telemetry and/or diagnostic data in a continuous sampling mode following the occurrence of the pre-imposed trigger event. The processor may be arranged to capture telemetry and/or diagnostic data for a pre-set time period following the occurrence of the pre-imposed trigger event. The processor may be arranged to cancel an indicator of a fault if the frequency of occurrence of the fault is below a predetermined threshold limit.

The device can identify faults from data input into it and can monitor some, or all, of the data input into it following the identification of a fault. For example, if a driver continues to drive following an oil malfunction indicator light (MIL) becoming illuminated this can damage the vehicle. The device would allow fleet managers and service centres to refute a driver's assertions of innocence in relation to damaging a vehicle with data.

The processor may be arranged to collate telemetry and/or diagnostic data and generate a notification of need for maintenance based upon the data. The transceiver unit may be arranged to transmit the notification to a base station.

This allows early diagnosis of a fault enabling a vehicle to be called in for servicing prior to the fault causing a breakdown of the vehicle with the attendant inconvenience and expense, for example in arranging recovery of the vehicle and also a replacement vehicle.

The processor of the device may be arranged to generate log data corresponding to data passing, either way, between the data reader and the on-board diagnostics system, and may be further arranged to either store the log data upon the storage device and/or output the log data to a base station via the transceiver unit.

This provides an independent log of data collected by a mechanic during an inspection of the vehicle, enabling a fleet manager or vehicle owner to contest vehicle warranty issues with the manufacturer.

The processor may be arranged to determine a preferred protocol of data transmission from the device via the transceiver unit, for example SMS, GSM or GPRS. Typically, this is determined by calculation of data volume and frequency of transmission of data.

This allows the efficient transmission of data to be effected from both financial and bandwidth considerations.

The processor may be arranged to control the output of data via the transceiver unit such that transmission of data occurs once a pre-determined time of travel and/or distance of travel has occurred from when the vehicle is stationary (or speed of travel is reached), for example 50 m.

This helps reduce the chances of the transceiver transmitting data in areas such as petrol stations where radio transmissions are forbidden.

The transceiver may be external to the data-monitoring device and connected wirelessly to another transceiver, for example the driver's mobile phone.

The transceiver unit may be arranged to receive data from a base station. The data may correspond to updated or new configuration data to configure the processor, for example new parameters to monitor or new pre-determined threshold values.

The transmission of data, in particular configuration data, to the device allows the use of the device in a number of scenarios without the need for human intervention, thereby deskilling the updating of the devices operating system.

The transceiver unit may be arranged to operate on a pre-paid basis over a cellular telecommunications network. The processor may be arranged to calculate available airtime over the network and may further be arranged to request further airtime credit, from a network provider via the transceiver unit.

The output port may be arranged to connect to a data reader.

The device may be arranged to be retrofitted into a vehicle. The device may be installable in a vehicle by fastening means arranged to fasten the device in position and by connecting the input port to an output port of an on-board diagnostics system of the vehicle.

According to a further aspect of the present invention there is provided a connector comprising a male head and a female head having a cable therebetween, one of the heads being arranged to connect to an output port of an on-board diagnostics system of a vehicle, the other head being arranged to connect to a device according to the first aspect of the present invention.

The connector may also comprise a further head in communication with the cable arranged to provide a substitute output for the on-board diagnostics system.

One of the heads may be configured to be releasably engageable with a complimentarily shaped output port of the on-board diagnostics system.

The one of the heads may be configured to be releasably engageable with a manufacturer specific output port of the on-board diagnostics system. The one of the heads may be configured to be releasably engageable with a vehicle model specific output port of the on-board diagnostics system.

The other of the heads may be configured to be releasably engageable with a complimentarily shaped input port of a device according to an earlier aspect of the present invention.

The use of such a connector allows a single vehicle data monitoring device to be used for a number of vehicles made by any one of a number of manufacturers. Additionally, such a connector allows the connection to be made without altering the vehicle. Any such alteration could invalidate a vehicle's warranty, and so not altering the vehicle may be advantageous. The use of a ‘universal’ connector having only one differing end (of a variety of different shapes/configurations) dependent upon the make and model of vehicle simplifies the installation process allowing installation to be carried out by untrained staff with a low probability of incorrect installation.

The connector may be arranged to provide a data conduit between an external data reader and a device according to an earlier aspect of the present invention such that a processor of the device can log data passing, either way, between the data reader and the on-board diagnostics system.

This provides an independent log of data collected by a mechanic during an inspection of the vehicle, enabling a fleet manager or vehicle owner to contest vehicle warranty issues with the manufacturer.

According to a further aspect of the present invention there is provided a method of monitoring vehicle telemetry and/or diagnostic data, operable whilst the vehicle is in use, comprising the steps of:
(i) sampling telemetry and/or diagnostic data from a vehicle diagnostics system via an output of the system;
(ii) comparing the data sampled in step (i) to stored threshold data at a processor;
(iii) outputting metric data indicative of the result of the comparison of step (ii) to a data storage device and/or a transceiver unit, the transceiver unit being arranged to transmit the metric data to a remote base station.

The method may comprise connecting an input port linked to the processor to an output port of a data bus of the on-board diagnostics system.

The method may comprise transmitting data to the base station either periodically or continually.

The method may comprise disconnecting, selectively, the processor from the diagnostics system upon detection of a data reader being connected to the diagnostics system. The method may comprise monitoring a data bus of the diagnostics system in order to detect if the data reader is connected to the data bus and disconnecting the processor from the data bus should a data reader be connected to the data bus. Alternatively, or additionally, the method may comprise receiving data at the processor corresponding to current and/or voltage drawn by the data reader when connected to the diagnostics system and disconnecting the processor from the diagnostics system should the data reader be connected to the diagnostics system.

The method may comprise sensing which type of vehicle diagnostics system the processor is connected to and configuring data connections accordingly.

The method may comprise storing data corresponding to a log of telemetry and/or diagnostic data at the data storage device, the data having been generated at the processor. The method may comprise accessing of the data corresponding to a log of telemetry and/or diagnostic data by a data reader via an output port linked to the processor and/or via the transceiver unit.

The method may comprise generating a fault code data corresponding to telemetry and/or diagnostic data having a value outside of the predetermined threshold criterion at the processor. The method may comprise storing the fault code data on the storage device. Alternatively, or additionally, method may comprise routeing the fault code data, selectively, to either, or both, of the output port or the transceiver unit by the processor. The method may comprise capturing telemetry and/or diagnostic data following the occurrence of a pre-imposed trigger event in the data. The method may comprise capturing telemetry and/or diagnostic data in a continuous sampling mode following the occurrence of the pre-imposed trigger event. The method may comprise capturing telementry and/or diagnostic data for a pre-set time period following the occurrence of the pre-imposed trigger event. The method may comprise cancelling an indicator of a fault if the frequency of occurrence of the fault is below a pre-determined threshold limit.

The method may comprise collating telemetry and/or diagnostic data and generating a notification of need for maintenance based upon the data where appropriate. The method may further comprise transmitting the notification to the base station.

The method may comprise generating log data corresponding to data passing, either way, between the data reader and the on-board diagnostics system at the processor. The method may further comprise either storing the log data upon the storage device and/or transmitting the log data to the base station via the transceiver unit.

The method may comprise receiving configuration data from the base station. The method may comprise configuring the processor in response to the receipt of the configuration data.

The method may comprise transmitting and/or receiving data at the transceiver unit via a cellular telecommunications network. The method may comprise calculating available pre-paid airtime over the network and may further comprise requesting further airtime, credit, from a network provider via the transceiver unit.

According to a further aspect of the present invention there is provided a motor vehicle comprising a device according to an earlier aspect of the present invention and/or comprising a device arranged to execute the method of an earlier aspect of the present invention.

Embodiments of the invention will now be described in detail, by way of example only, and with reference to the accompanying drawings, of which:

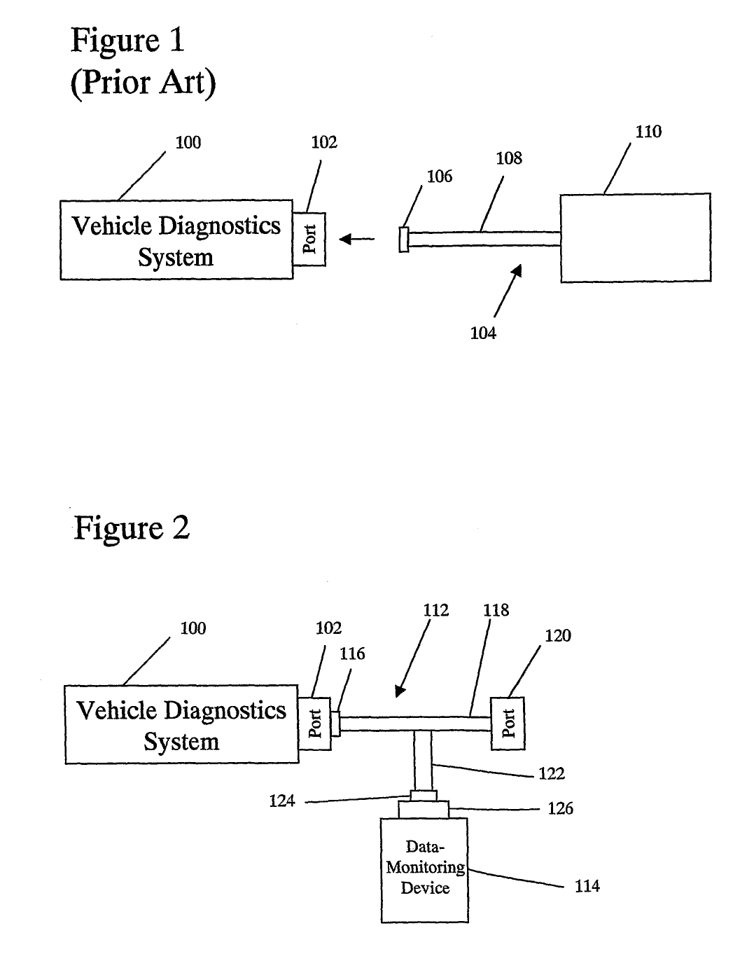

FIG. 1 shows a prior art system for obtaining information from a vehicle diagnostics system;

FIG. 2 shows schematically how a cable and data-monitoring device according to an embodiment of the present invention can be used with a vehicle diagnostics system;

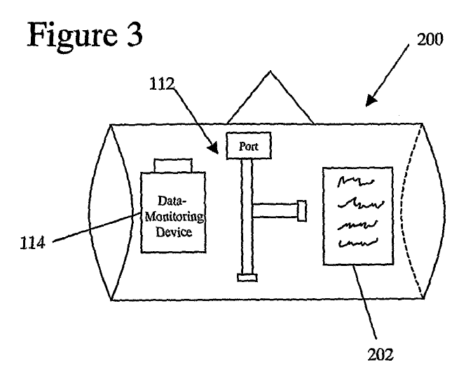

FIG. 3 shows a kit for obtaining information from a vehicle diagnostic system;

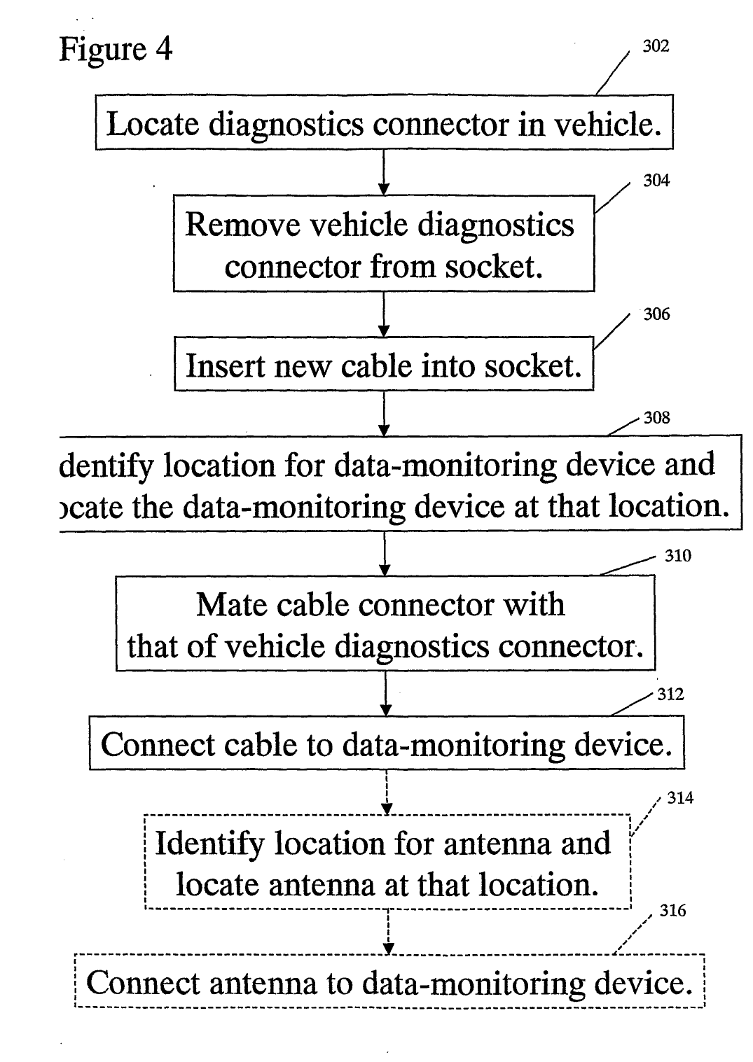

FIG. 4 shows a flow chart showing the steps performed when installing a cable and data-monitoring device according to an embodiment of the present invention into a vehicle;

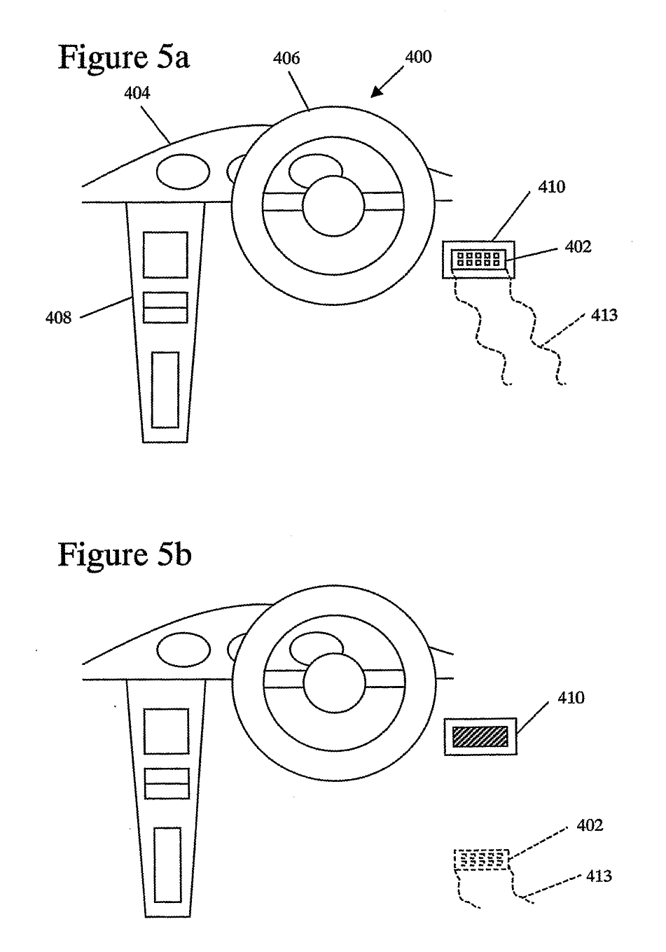

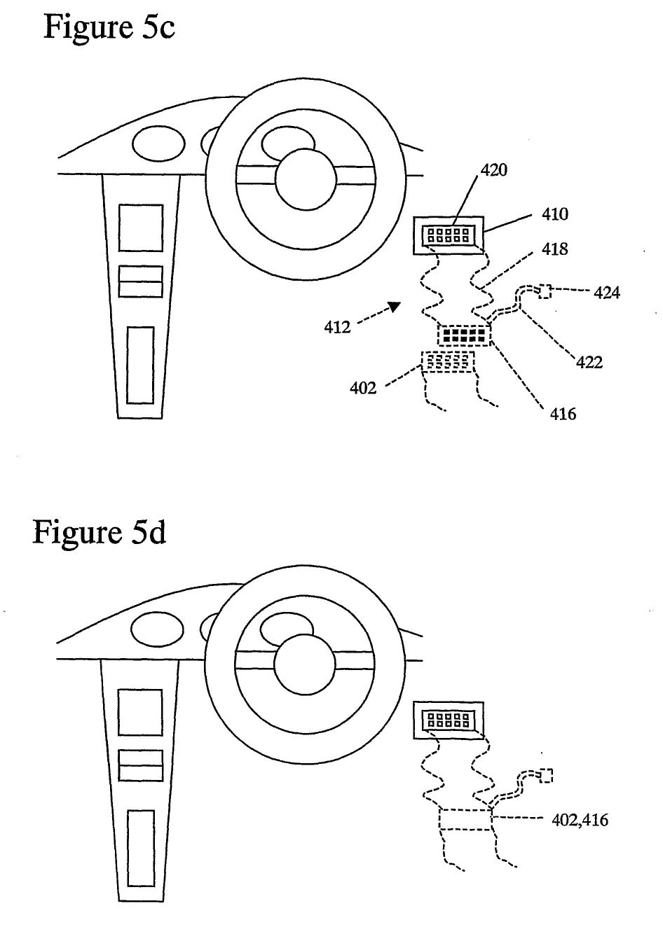

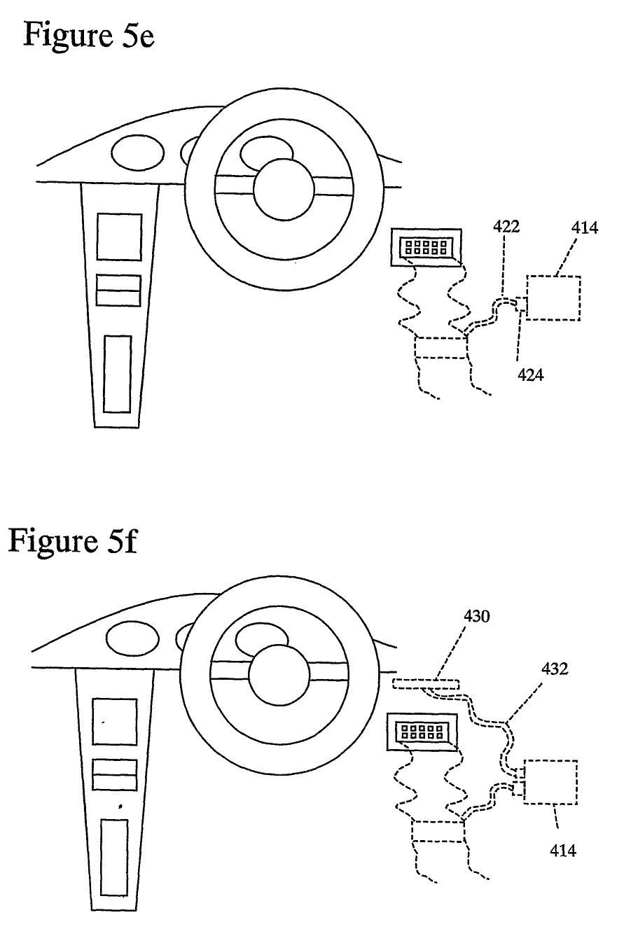

FIGS. 5a to 5f show graphically the steps performed when installing a cable, data-monitoring device and antenna according to an embodiment of the present invention into a vehicle; and

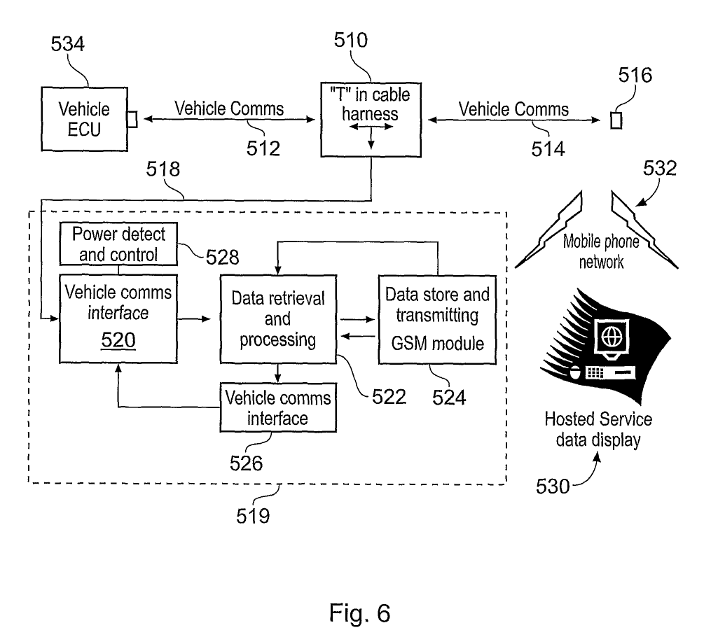

FIG. 6 shows a system for monitoring vehicle diagnostic data in accordance with an embodiment of the invention.

The present invention relates to monitoring data produced by a vehicle diagnostics system. Vehicle diagnostics systems are known in the art and can monitor data relating to the vehicle including, but not limited to, exhaust emissions, speed, distance travelled, fuel consumption, and electrical fault data. Typically a mechanic can attach a reader directly to the vehicle diagnostic system to enable them to analyse the diagnostic data and determine what maintenance work is required on the vehicle. It will be appreciated that by “mechanic” it is intended to include any technician, engineer, or other person who may access the vehicle diagnostic data.

FIG. 1 shows a vehicle diagnostics system 100 as is known in the art. The vehicle diagnostics system 100 has a computer processor (not shown) which is in communication with a diagnostics connector that has an interface or port 102 through which data produced by the vehicle diagnostics system 100 can be accessed. In Europe the port 102 is a standard interface known as a European On Board Diagnostics Interface (EOBD). Other standard interfaces may be used in other parts of the world.

It is known in the art for a mechanic to plug a data reader 104 into the port 102 to retrieve data that has been collected and stored in the vehicle diagnostics system 100. This is typically performed when the vehicle is serviced, or otherwise taken to a garage.

The data retrieval device 104 comprises a male connector 106, a data-retrieval device 110 that includes a computer memory arranged to store the retrieved data (and optionally a computer processor to process the data), and a cable 108 between the male connector 106 and the data-retrieval device 110. The male connector 106 plugs into the port 102 of the vehicle diagnostics system 100 when data is to be retrieved from the vehicle diagnostics system 100, and the retrieved data is communicated to the data-retrieval device 110 via the cable 108.

The mechanic can then assess the retrieved data to determine what work, if any, is required to maintain the vehicle in good condition.

A disadvantage of the prior art system is that data is only retrieved when the vehicle is taken in to a garage and the owner of the vehicle must rely on the mechanic to correctly, and honestly, interpret the data that they retrieve from the vehicle diagnostics system.

FIG. 2 shows a cable 112 and data-monitoring device 114 of an embodiment of the present invention connected to a vehicle diagnostics system 100 to monitor data produced by the vehicle diagnostics system 100.

The cable 112 comprises a male connector 116, a substitute port 120, and a first wire 118 that connects the male connector 116 to the substitute port 120. The male connector 116 is arranged to interconnect with the standard vehicle port 102 of the vehicle diagnostics system 100. The substitute port 120 is of the same type (interface configuration) as the vehicle port 102 on the vehicle diagnostics system 100. This portion of the cable 112 serves to provide a substitute port 120 that a mechanic can plug their data reader 104 (as shown in FIG. 1) into to retrieve data directly from the vehicle diagnostics system 100. This allows a mechanic to retrieve data from the vehicle diagnostics system 100 in the same way as they would in the prior art, often without being alerted to the fact that cable 112 has been introduced into the communication path between the vehicle diagnostics system 100 and the mechanic's data reader.

A second wire 122 splits off from the first wire 118 in between the male connector 116 and the substitute port 120. The second wire has a connector 124 at its distal end that is arranged to connect to a data-monitoring device port 126 on the data-monitoring device 114. FIG. 2 shows the connector 124 connected to the data-monitoring device port 126.

In some embodiments the second wire 122 and data-monitoring device 114 can be releasably attached to each other, in others they may be permanently attached to each other.

The second wire 122 is connected to the first wire 118 such that data produced by the vehicle diagnostics system 100 can be communicated to both the connector 124 at the distal end of the second wire 122, and the substitute port 120 at the end of the first wire 118. Data may be communicated to both the connector 124 and the substitute port 120 at the same time, or data may only be communicated to one of the connector 124 and the substitute port 120 at any given time. Data may be “tapped-off” to the data-monitoring device connector 124 from between the male connector 116 and the substitute port 120.

A user (who may be the owner of the vehicle or some other third party) may be able to monitor data obtained by the data-monitoring device 114 to monitor for faults themselves at any given time. The user may also be able to verify any data that a mechanic obtains when the vehicle is being serviced, and may be able to verify (possibly using appropriate software) that recommended work is in fact necessary or desirable.

In some embodiments, a known mechanic's data reader may be able to indicate to the mechanic that a third-party device is simultaneously, with them, retrieving data from the vehicle diagnostics system 100. In embodiments where the third-party device is the data-monitoring device 114, the data-monitoring device 114 can be arranged to stop monitoring the vehicle diagnostics system 100 when a mechanic attaches their data reader 104 to the substitute port 120. This can help reduce the chances that the mechanic becomes aware of the existence of data-monitoring device 114. Communication between the data-monitoring device 114 and the vehicle diagnostics system 100 can resume when the mechanic removes their data reader 104 from the substitute port 120.

Communication between the vehicle diagnostics system 100 and the data-monitoring device 114 may be arranged to cease and/or resume automatically, or it may require a user to indicate to the data-monitoring device 114 (for example, by pressing a button) whether or not the mechanic has connected a data reader 104 to the substitute port 120.

In some embodiments the data-monitoring device 114 can transmit the data that it monitors from the vehicle diagnostics system 100 to a remote receiver over a mobile telephony network. In some embodiments the vehicle diagnostics system 100 is in constant communication with the data-monitoring device 114, and the data-monitoring device 114 can periodically, continuously, or upon the occurrence of an event, transmit data that it has monitored from the vehicle diagnostics system 100 to a remote receiver.

In other embodiments the data-monitoring device 114 can store data in a local memory, such that the data can be downloaded when required by any suitable means.

In some embodiments the data-monitoring device 114 may be arranged to monitor the data that is transferred between the vehicle diagnostics system 100 and the mechanic's data reader. This can enable the owner of the vehicle to verify the advice that the mechanic gives them, and can help reduce the chances that the mechanic gives the owner of the car erroneous advice, or recommends that incorrect or unnecessary work is performed on the vehicle.

FIG. 3 shows a kit 200 for obtaining data from a vehicle diagnostics system. The kit comprises a data-monitoring device 114, a cable 112 and a set of instructions 202. The data-monitoring device 114 and the cable 112 are as illustrated in FIG. 2, and the set of instructions 202 provide a user with steps that they should follow to fit the data-monitoring device 114 and the cable 112 to a vehicle. In some embodiments the cable 112 may be integral with the data-monitoring device 114. In some embodiments the instructions are optional and may not be provided in the kit

One way of fitting the data-monitoring device 114 and the cable 112 to a vehicle is discussed in relation to FIG. 4.

At step 302, a user locates the diagnostics connector (equivalent to the port/interface 102 shown in FIGS. 1 and 2) in the vehicle. The vehicle diagnostics connector will typically be located within a socket in the vehicle, often within 30 cm of the central steering column. At step 304, the user removes the vehicle diagnostics connector from the socket within which it is located so that an empty socket remains where the vehicle diagnostics connector used to be. The vehicle diagnostics connector remains attached to the vehicle diagnostics system by a cable, and is left hanging in a cavity behind the socket so that it can be used later. Removing the vehicle diagnostics connector may require the removal of some trim around the socket so that the user can gain access to the socket. Preferably any removed trim can be replaced to the vehicle once the new apparatus has been fitted to the vehicle so that from an external view there is little, or no, evidence of the new apparatus.

There is normally a cavity or some space behind, or very close to, the vehicle diagnostics connector. If there is not, then in some embodiments the cable may be long enough to move the bulky joint with the existing vehicle connector to a place where there is a suitable cavity.

At step 306, a new cable (for example cable 112 in FIGS. 2 and 3) is inserted into the empty socket. The new cable has a substitute diagnostics connector joined to a male connector by a first wire. A second wire splits off the first wire between the substitute diagnostics connector and the male connector. A data-monitoring device connector is joined to the distal end of the second wire. It will be appreciated that instead of wires the data monitoring device and the connector would be connected by strips of metal, or fibre optics, or wirelessly: they are connected for communication and the vehicles on-board EOBD can talk to an interrogator's diagnostic device, and embodiments of the present invention involve listening in.

The substitute diagnostics connector is of the same type as the vehicle diagnostics connector that was removed from the socket at step 304. The new cable is inserted such that the substitute diagnostics connector on the new cable is exposed in the socket in the same way as the original, existing, vehicle diagnostics connector was exposed prior to its removal from the socket. The rest of the new cable extends into the cavity behind the socket and is obscured from view. This can cause a mechanic to believe that they are connecting directly to the existing, original, vehicle diagnostics connector, when in fact they will be connecting indirectly to the vehicle diagnostics system via the substitute diagnostics connector.

At step 308, the user identifies a suitable location in the vehicle for the data-monitoring device and then mounts or secures the data-monitoring device at that location. In some embodiments the data-monitoring device is mounted/located such that it is out of sight. This can help to continue to cause the mechanic to believe that they are connecting directly to the vehicle diagnostics connector. In some embodiments the data-monitoring device is located such that it avoids heater/air-conditioning outlets that could damage the data-monitoring device. For safety reasons the data-monitoring device may also be located such that it avoids cable looms and/or air bags.

The male connector on the end of the first wire is mated with the vehicle diagnostics connector in the cavity behind the socket at step 310. This ensures that data produced by the vehicle diagnostics system is communicated to the substitute diagnostics connector via the first wire and can be monitored at the substitute diagnostics connector in the same way that data could be monitored directly at the vehicle diagnostics connector.

At step 312, the data-monitoring device connector on the second wire is connected to the data-monitoring device such that data produced by the vehicle diagnostics system can be communicated to the data-monitoring device as well as to the substitute diagnostics connector.

Optionally, a user can identify a location in the vehicle for a GSM antenna and locate the antenna at that location, at step 314. The antenna is arranged to transmit data received by the data-monitoring device to a remote location. A suitable location for the GSM antenna may be on the underside of the dashboard. The location may be such that the antenna, or a cable attached to the antenna, is not close to any metal, speakers, speaker cables, airbags or cable looms as these could interfere with the antenna. The antenna is then connected to the data-monitoring device at step 316.

FIGS. 5a to 5f show graphically the steps performed when installing a data-monitoring device 414, a cable 412 and an antenna 430 according to an embodiment of the present invention. It will be appreciated that in some embodiments the antenna 430 could be integral with the data-monitoring device 414. In other embodiments there is no antenna at all as data is not transmitted to a remote location; data is stored locally in the data-monitoring device 414. In such embodiments a user can connect directly or indirectly to the data-monitoring device 414 to retrieve that data that has been stored locally on it when required.

FIG. 5a shows the interior of a vehicle 400. Only the steering wheel 406, dashboard 404, central column 408 and European On Board Diagnostics Interface (EOBD) 402 are shown in order to aid clarity. The EOBD 402 provides an interface to vehicle data as discussed above.

The EOBD interface 402 is housed in a socket 410 provided mounted in a bulkhead wall, or other surface, and has a cable 413 that extends from the EOBD interface 402 to a vehicle diagnostics system (not shown). The cable 413 extends through a cavity behind the socket 410, and is shown in dashed lines as it is obscured from view.

As shown in FIG. 5b, a user has removed the EOBD 402 from the socket 410 and allowed the EOBD interface 402 to drop back into the space, or cavity, behind the socket 410. Removing the EOBD 402 from the socket 410 leaves an empty space where the EOBD 402 used to be. Trim may need to be removed from the area surrounding the socket 410 in order to gain access to the socket 410 and the EOBD 402. Preferably, the trim can be replaced once the new equipment has been fitted.

A user can then insert a new cable 412 into the cavity behind the socket 410 as shown in FIG. 5c, and couple it to the EOBD interface (i.e. plug the cable 412 into the EOBD interface 402). The new cable 412 has a substitute EOBD connector 420 and a male connector 416 at opposite ends of a first wire 418. A second wire 422 branches off from the first wire 418 in the vicinity of the male connector 416. A data-monitoring device connector 424 is attached to a distal end of the second wire 422. It will be appreciated that the installer may connect the EOBD interface 402 and the cable 412 when the interface is readily accessible, in front of the surface that defines the socket 410, and the EOBD interface, with the cable 412 coupled to it, may then be pushed through the socket hole.

The substitute EOBD connector 420 is then mounted in, and exposed in, the socket 410 in the same way that the original EOBD connector 402 was exposed in FIG. 5a. The rest of the new cable 412 extends away from the substitute EOBD 420 into the cavity behind the socket 410 and is obscured from view. If not connected prior to pushing the EOBD interface 402 through the cavity 410, the male connector 416 is disposed close to the interface 402 so that it can be connected with the original EOBD 402 that was removed from the socket 402 as shown in FIG. 5c.

It will be appreciated that in other embodiments the EOBD connectors (or any other interface that provides access to data relating to parameters of a vehicle) may be male, and therefore the male connector 416 shown in this embodiment would be female in order to engage with a male EOBD connector.

In FIG. 5d, the original EOBD 402 has been connected to the male connector 416. This ensures that anyone who connects to the substitute EOBD 420 will be able to obtain data in the same way as if they were connected directly to the original EOBD 402.

In FIG. 5e, a data-monitoring device 414 has been connected to the cable 412 by the data-monitoring device connector 424.

An antenna 430 has been connected to the data-monitoring device 414 by wire 432 in FIG. 5f. The antenna 430 enables data that has been monitored by the data-monitoring device 414 to be transmitted to a remote location. This is optional.

It will be appreciated that some or all of the new cable 412, and/or the data-monitoring device 414 and/or antenna 430 do not need to be located in the cavity behind the socket 410—this is just one example of where they can be located. In other embodiments they can be located on the underside of the dashboard, behind trim around the dashboard or in a foot well or in the centre console.

FIG. 6 shows schematically a system for monitoring vehicle diagnostic data according to an embodiment of the present invention. In order to install a device 519 embodying the invention in a vehicle, a connection must be made into the existing electronic systems of the vehicle. In cases where the device 519 is to be installed in a pre-existing vehicle, this can conveniently be achieved by providing a connector 510 that replicates the signals present on an EOBD connector of the vehicle. In this example, the connector 510 has an input line 512 that is connected to electronic systems of the vehicle to receive EOBD signals from components such as a vehicle electronic control unit 534. The connector has two output lines onto which signals on the input line 512 are replicated. A first output line 514 is terminated in a J1962 EOBD connector 516 that can be used in the same manner as a standard EOBD connector.

The second output line 518 carries signals for processing by functional modules of the device 519 in accordance with a method embodying the invention.

The device 519 includes functional modules to process the EOBD signals. These modules include a vehicle interface module 520, a data-retrieval and processing module 522 and a data store and transmission module 524. The data retrieval and processing module 522 can control operation of the vehicle interface module 520 through a communication control module 526. A power detect and control module 528 also influences operation of the vehicle interface module 520.

The data store and transmission module 524 is capable of transmitting to and receiving data from a remote base station 530 under the control of the processing module 522. In this example, the data is transmitted over a mobile telephony network 532. This allows the processing module 522 to transmit data to and receive data from the remote base station 530. In addition, the data store and transmission module 524 includes a non-volatile data store, such as a hard drive or non-volatile solid state memory within which the processing module 522 can store data for later retrieval.

The data retrieval and processing module 522 can access all data that is available at the EOBD connector and converts that data into signals that are compatible with inputs to the processing module. The data retrieval and processing module 522 executes a program that can access the data and perform actions based upon the content of the data. In accordance with the program, in response to specific events within the data, the processor causes data to be sent to the base station or stored within the data store and transmission module 524.

1. A method of installing a vehicle data-monitoring device and a substitute vehicle data connector into a vehicle having a vehicle data-monitoring system with an existing vehicle data connector, the method comprising the steps of:
removing the existing vehicle data connector from a socket in the vehicle;
inserting the substitute vehicle data connector into the socket;
connecting the vehicle data connectors such that the existing vehicle data connector is in communication with the vehicle data-monitoring device and also in communication with the substitute vehicle data connector.

2. The method of claim 1 further comprising connecting the vehicle connector to the substitute vehicle data connector with a first cable having a vehicle connector end and a substitute vehicle data connector end.

3. The method of claim 2 further comprising connecting the vehicle connector to the vehicle data-monitoring device with a second cable having a vehicle connector end and a vehicle data-monitoring device end.

4. The method of claim 3 wherein the vehicle connector end of the first cable is the same connector as the vehicle connector end of the second cable.

5. The method of claim 3 wherein the second cable branches off from the first cable.

6. The method of claim 1 wherein the substitute vehicle data connector is the same type as the existing vehicle data connector.

7. The method of claim 6 wherein the substitute vehicle data connector and the existing vehicle data connector are OBD or EOBD interfaces.

8. The method of claim 1 further comprising connecting an antenna to the data-monitoring device.

9. The method of claim 8 wherein the antenna is arranged to transmit over a mobile telephony network.

10. The method of claim 1 wherein the data-monitoring device is installed such that it is obscured from view, when the bonnet of a vehicle is opened and the substitute vehicle data connector is observed.

11. The method of claim 10 wherein the data-monitoring device is installed in a cavity behind the socket.

12. The method of claim 1 further comprising connecting the vehicle connector to the substitute vehicle data connector with a first cable having a vehicle connector end and a substitute vehicle data connector end, wherein the data-monitoring device is installed such that it is obscured from view, when the bonnet of a vehicle is opened and the substitute vehicle data connector is observed, and the first cable is connected such that it is obscured from view.

13. The method of claim 12 wherein the first cable is connected such that it is located in a cavity behind the socket.

14. The method of claim 3 wherein the data-monitoring device is installed such that it is obscured from view, when the bonnet of a vehicle is opened and the substitute vehicle data connector is observed and the second cable is connected such that it is obscured from view.

15. The method of claim 14 wherein the second cable is connected such that it is located in a cavity behind the socket.

16. The method of claim 8 wherein the antenna is connected such that it is obscured from view.

17. The method of claim 1 wherein the vehicle data-monitoring system is a vehicle diagnostics system and/or a vehicle telemetric system.

18. A kit comprising a data-monitoring device, data transfer means having a substitute vehicle data connector, and a set of instructions for installing the data-monitoring device and data transfer means into a vehicle having a vehicle data-monitoring system with an existing vehicle data connector, wherein the data transfer means is arranged, in use, to provide a communication path between the data-monitoring device and the existing vehicle data connector, and also to provide a communication path between the substitute vehicle data connector and the existing vehicle data connector.

19. The kit of claim 18 wherein the substitute vehicle data connector is the same type as the existing vehicle data connector associated with the vehicle data-monitoring system.

20. The kit of claim 19 wherein the substitute vehicle data connector and the existing vehicle data connector are OEBD interfaces.

21. The kit of claim 18 wherein the data transfer means is a cable.

22. The kit of claim 21 wherein the cable is releasably attachable to the data-monitoring device.

23. The kit of claim 21 wherein the cable is integral with the data-monitoring device.

24. The kit of claim 18 further comprising an antenna arranged to transmit data from the data-monitoring device.

25. The kit of claim 24 wherein the antenna is arranged to transmit over a mobile telephony network.

26. The kit of claim 18 wherein the communication path between the existing vehicle data connector and the data-monitoring device is interruptable when data is transferred between the existing vehicle data connector and the substitute vehicle data connector.

27. The kit of claim 26 wherein the communication path between the existing vehicle data connector and the data-monitoring device is capable of being resumed when data transfer between the existing vehicle data connector and the substitute vehicle data connector ceases.

28. The kit of claim 18 wherein the vehicle data-monitoring system is a vehicle diagnostics system.

29. A vehicle comprising a vehicle data-monitoring system having a previously fitted vehicle data connector, a data-monitoring device and a subsequently fitted data connector, wherein the previously fitted vehicle data connector is in communication with the data-monitoring device and also in communication with the vehicle data connector.

30. An on-board vehicle diagnostics system comprising a diagnostics processor, a first on-board diagnostics interface connector and a second on-board diagnostic interface connector, and a vehicle data acquisition and/or monitoring device that is additional to the diagnostics processor; the first connector being coupled to the vehicle data acquisition and/or monitoring device and the second connector being exposeable for coupling to a releasably couplable processor interrogator or data acquisition device.

31. A vehicle comprising a vehicle data-monitoring system having a vehicle EOBD or OBD processor, and first and second interface connectors adapted to communicate with the processor.

32-34. (canceled)
